(19) United States
(12) Patent Application Publication
(10) Pub. No.: US 2015/0044113 A1
(43) Pub. Date: Feb. 12, 2015

(54) Potash Processing with Mechanical Vapor Recompression

(71) Applicants: J. Clair Batty, North Logan, UT (US); Brett Boissevain, Logan, UT (US)

(72) Inventors: J. Clair Batty, North Logan, UT (US); Brett Boissevain, Logan, UT (US)

(73) Assignee: UTAH STATE UNIVERSITY, North Logan, UT (US)

(21) Appl. No.: 13/964,249

(22) Filed: Aug. 12, 2013

(51) Int. Cl. B01D 9/00

(52) U.S. Cl. CPC B01D 9/0031
USPC 423/184; 422/245.1

(57) ABSTRACT

A potash-extraction system and method for extracting potash from a brine containing potash without the use of water-consuming evaporation ponds or additional chemicals is disclosed. The potash processing system uses a mechanical-vapor recompression (“MVR”) cycle to separate salt and then potash from a sylvinite brine containing salt and potash. In embodiments, the latent heat recovered from condensing vapor may be used to boil the brine to precipitate some salt and remove some water (in the form of water vapor) from the brine. The remaining potash-concentrated brine may then be cooled to precipitate potash from the solution. The precipitated potash may then be further processed for final use.

### TECHNICAL FIELD

The present disclosure relates to extracting potash from a sylvinite brine solution containing potassium chloride (“KCl” or “potash”) and Sodium Chloride (“NaCl” or “salt”).

### BACKGROUND

Potash refers to potassium containing compounds, particularly potassium chloride. Potash is primarily used with nitrogen and phosphorus in fertilizers. One method for producing potash, sometimes referred to as solution mining, includes injecting a mine containing sylvinite deposits with brine, water, or a salt-saturated brine, which dissolves crystals containing potash. The potash-containing brine is then pumped out of the mine and deposited in nearby evaporation ponds where potash and salt precipitate out of the brine solution as the water evaporates. The precipitated potash and salt are then gathered and transported to a processing facility where potash and salt are chemically separated and the potash is processed for sale. This process requires large evaporation ponds located close to the potash mine and additional chemical processing at a potash processing facility.

### SUMMARY

The present disclosure in aspects and embodiments describes a potash processing system and method for extracting potash from a sylvinite brine containing potash without the use of water-consuming evaporation ponds or additional chemicals. The potash processing system uses heat generated from a mechanical vapor recompression (“MVR”) cycle to increase the potash concentration in a brine containing potash and salt before separating potash from the brine. In embodiments, work produced by the MVR cycle may be converted to heat, which heats the brine to precipitate some salt from the brine. The remaining potash-concentrated brine may then be cooled to precipitate potash from the solution. The precipitated potash may then be further processed for final use.

In embodiments, a potash processing system includes a first and second stage crystallizer and a concentrator. The potash processing system may be configured to receive a sylvinite brine comprising potash, salt, and water from a sylvinite brine source; boil the sylvinite brine in the concentrator to produce precipitated salt, water vapor, and potash-concentrated brine; cool the potash-concentrated brine in the first-stage crystallizer to produce first-stage precipitated potash and saturated-potash brine; and cool the saturated-potash brine in the second-stage crystallizer to produce second-stage precipitated potash and cooled saturated-potash brine.

In other embodiments, the potash processing system may be configured to return to the sylvinite brine source more than 80% of the water received from the sylvinite brine source. In other embodiments, the potash processing system may be further configured to capture from the sylvinite brine more than 80% of the potash received from the sylvinite brine source. In still other embodiments, the potash processing system is configured to recycle the cooled saturated-potash brine back in with the sylvinite brine prior to boiling the sylvinite brine.

In other embodiments, the potash processing system may include a mechanical vapor recompression cycle, wherein the water vapor produced in the concentrator is compressed by a blower in the mechanical vapor recompression cycle to produce superheated vapor and the potash processing system is configured to boil the sylvinite brine in the concentrator with heat from the superheated vapor. In another embodiment, the potash processing system may further comprise a pre-heater configured to pre-heat the sylvinite brine from condensate produced by the concentrator. Additionally, the mechanical vapor recompression cycle and the pre-heater may be installed together on a single, transportable skid.

In another embodiment, the potash processing system may be configured to combine the sylvinite brine and the cooled saturated-potash brine into a pre-first stage crystallizer cooling solution and cool the potash-concentrated brine in the first-stage crystallizer with the pre-first stage crystallizer cooling solution.

A potash processing system may also include a first-stage crystallizer centrifuge configured to extract potash paste from the first-stage precipitated potash and the saturated potash brine; a second-stage crystallizer centrifuge configured to extract potash paste from the second-stage precipitated potash and the cooled saturated-potash brine; a dryer configured to dry the potash paste and produce dried potash and dryer waste heat gas; and an exhaust scrubber configured to heat the sylvinite brine with the dryer waste heat gas.

The present disclosure also describes methods for extracting potash from a sylvinite brine source. A method may include receiving a sylvinite brine comprising potash, salt, and water from a sylvinite brine source; boiling the sylvinite brine in a concentrator to produce precipitated salt, water vapor, and potash-concentrated brine; cooling the potash-concentrated brine in a first-stage crystallizer to produce first-stage precipitated potash and saturated-potash brine; and cooling the saturated-potash brine in a second-stage crystallizer to produce second-stage precipitated potash and cooled saturated-potash brine.

In other embodiments, a method for extracting potash from a sylvinite brine source may include returning to the sylvinite brine source more than 80% of the water received from the sylvinite brine source. Additionally, a method may include retaining from the sylvinite brine more than 80% of the potash received from the sylvinite brine source. A method may also include combining the cooled saturated-potash brine and the sylvinite brine into a brine cooling solution prior to boiling the sylvinite brine in the concentrator.

In embodiments, the boiling step in the method for extracting potash from a sylvinite brine source may include producing superheated water vapor by compressing the water vapor with a blower in a mechanical vapor recompression cycle and transferring heat from the superheated water vapor into the sylvinite brine. Similarly, cooling the potash-concentrated brine in the first-stage crystallizer may include cooling the potash-concentrated brine with the sylvinite brine and the cooled saturated-potash brine.

A method for extracting potash from a sylvinite brine source may include pre-heating the sylvinite brine in a pre-heater with condensate produced by the concentrator. Additional steps that may be added may include: extracting potash paste from the first-stage precipitated potash and the saturated potash brine in a first-stage crystallizer centrifuge; extracting potash paste from the second-stage precipitated potash and the cooled saturated-potash brine in a second-stage crystallizer centrifuge; drying the potash paste in a dryer to produce dried potash and dryer waste heat gas; and heating the sylvinite brine with the dryer waste heat gas in an exhaust scrubber prior to the sylvinite brine entering the concentrator.

In the methods described above, the potash processing system may be configured such that the first-stage crystallizer and the second-stage crystallizer are installed together on a single, transportable skid.

Methods for extracting potash from a sylvinite brine source may also include incrementally heating the sylvinite brine in the first-stage crystallizer, then a pre-heater, and then the concentrator to produce the potash concentrated brine; and then incrementally cooling the potash concentrated brine in the first-stage crystallizer and then the second-stage crystallizer to produce precipitated potash.

In the embodiments, the potash may be extracted from the sylvinite brine source without the use of an evaporation pond.

### Temperature-Dependent Solubility of Potash and Salt

The potash extraction system and method take advantage of the temperature-dependent solubility characteristics of salt and potash in a salt-potash brine. In a salt-potash brine, salt has a lower solubility concentration than potash at higher temperatures (above 72° C.) and potash has a lower solubility concentration than salt at lower temperatures (below 72° C.). Increasing the temperature (e.g., up to 110° C. or boiling) of brine saturated with potash and salt produces salt precipitate, which may be mechanically extracted from the brine solution. Decreasing the temperature of the same brine (e.g., down to 50° C., or lower) produces potash precipitate, which may be mechanically extracted from the brine solution.

### Benefits of the Mechanical Vapor Recompression Cycle

The system and method advantageously use the energy efficiency of an MVR cycle to heat the salt-potash brine and precipitate salt from the brine to increase the potash concentration. The MVR cycle may operate at unique thermodynamic operating pressures, pressure increase across the blower(s) or compressor(s), and temperature differences across the heat exchangers so as to minimize power consumption and depreciation cost of heat exchangers and pressure vessels. In embodiments, the brine may be entirely heated by converting work produced from the MVR cycle into heat, without the need to burn natural gas or other hydrocarbons, or otherwise use other heating sources.

In other embodiments, the latent heat recovered by condensing superheated vapor produced through the MVR cycle may be used to boil the brine to precipitate some salt and remove some water (in the form of water vapor) from the brine. Using compressed water vapor in the MVR cycle has the advantage of decreasing the capital cost and potential environmental impact of the overall system. Water also has the advantage of having a boiling temperature in a target temperature range, a high heat of vaporization, and a high density as a liquid.

The brine feed flow through the MVR cycle may be controlled by monitoring the boiling temperature of the brine in the MVR cycle. Brine boiling temperature increases as a function brine concentration and may be referred to as “boiling point rise.” Therefore, the boiling temperature of the brine may be used as the feedback control for the brine feed flow rate through components within the MVR cycle, the concentrator, or for the entire potash processing system.

### Potash Process System Components

In embodiments, the potash processing system includes a brine preheater and concentrator heated by steam condensate and steam vapor, respectively, generated from the compressor or blower of an MVR system. The preheater and concentrator heat exchangers may heat the brine to an elevated temperature, which precipitates out some of the salt and increases the relative concentration of potash in the brine. The preheater preheats the brine solution before entering a concentrator where the brine solution is boiled. Water vapor from the concentrator is compressed in the compressor or blower of an MVR system to produce superheated vapor. The superheated vapor from the compressor or blower is then used to boil the brine in the concentrator, where at least some of the superheated vapor condenses. The condensate from the superheated vapor is then used in the preheater to preheat the brine before entering the concentrator. The preheater and concentrator may output separate flows of NaCl-precipitated slurry, potash-concentrated brine, water vapor, and water condensate. In effect, both the preheater and the concentrator may increase the relative concentration of potash in the brine solution as salt precipitates out and is captured from the brine solution, and as water is boiled off from the brine in the form of water vapor.

After being concentrated in the preheater and concentrator, concentrated potash brine is then pumped or transported to first and second stage crystallizers. The crystallizers separate potash from the potash-concentrated brine. The crystallizers cool the potash-concentrated brine to precipitate out potash from the brine. The crystallizers may be cooled by brine being pumped out of the ground, ground water from an aquifer, or by a heat exchanger that is itself cooled by ambient air or a vapor compression cycle, e.g., a refrigeration chiller.

Using brine extracted from the ground as an initial cooling source for a crystallizer increases the thermal efficiency of the potash processing system. Hot or warm brine in a crystallizer increases the incoming brine temperature before the brine enters the pre-heater or the concentrator. Increasing the brine temperature before the brine enters the pre-heater or concentrator decreases the energy required to heat the brine in the pre-heater or concentrator.

The remaining solution exiting the crystallizer, a potash-precipitated slurry, may then be passed through a centrifuge, which extracts a majority of the salt-brine solution, leaving damp potash paste. The potash paste may then be dried and pelletized or otherwise prepared for sale.

In embodiments, brine extracted from a centrifuge of the first-stage crystallizer may be re-introduced into the output stream of the first-stage crystallizer or otherwise recycled back through the potash processing system. Recycling the brine extracted from the centrifuge of the first-stage crystallizer reduces the potash processing system water requirements.

In still other embodiments, water extracted from a centrifuge of the second-stage crystallizer may be re-introduced into the initial brine feed source and used to cool the concentrated potash brine in the first stage crystallizer. Brine exiting the second-stage crystallizer in the form of a slurry and extracted from the centrifuge of the second-stage crystallizer is at a relatively low temperature. That brine may be advantageously used to help cool the concentrated potash brine in the first-stage crystallizer. Additionally, recycling the brine extracted from the centrifuge of the second-stage crystallizer reduces the potash processing system water requirements.

### Overall System Benefits

In embodiments, the processing system may be mobile, which means that the processing equipment can be built in a factory on transportable skids, hauled to a well site for an indefinite period of time, and then moved to new sites. The processing system may also be modular, which means the equipment may be scalable to the needs of specific well sites. Modularity enables the concept of reducing upfront investment and risk associated with large-scale central plant installations. Lessons learned from the early designed modular units can be incorporated into later installations. Resources on relatively isolated properties may be economically developed.

Modularity also enables scalability in size or number of various potash processing system components depending on the potash concentration of the brine available at specific well sites. For example, more preheaters or concentrators relative to the number of crystallizers may be required to economically process the potash if the brine solution contains a relatively low potash concentration. Likewise, more than one set of preheaters, concentrators or crystallizers may be deployed to fully exploit the resources at a given well site.

The disclosed processing system may dramatically reduce consumptive water use as compared to open-pond, solar-evaporation potash processing. In embodiments, water vapor boiled from the brine in the concentrator is almost entirely recovered and reused. This has the added benefit that the only water lost is that water still contained in the damp paste or paste emerging from a centrifuge.

The system may also be used in colder climates where open-pond potash processing is not feasible. Significantly decreased environmental impact, such as reduced water and energy consumption, combined with a relatively small and mobile installation footprint, may increase the likelihood and decrease the cost of permitting at a well site.

In preferred embodiments, high-energy efficiency comparable to that achieved in large-scale, central-plant type installations, may be an important part of making the MVR cycle-based potash processing system both technically and economically productive.

### BRIEF DESCRIPTION OF THE DRAWINGS

FIG. 1 illustrates the solubility equilibrium lines of NaCl and KCL as a function of temperature in a salt-potash brine;

FIG. 2 illustrates the weight percent solubility of NaCl and KCl as a function of temperature in a salt-potash brine;

FIG. 3 illustrates a potash processing system; and

FIG. 4 illustrates another embodiment of potash processing system.

### DETAILED DESCRIPTION

The present disclosure covers apparatuses and associated methods for processing potash. In the following description, numerous specific details are provided for a thorough understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as illustrated in some aspects in the drawings, is not intended to limit the scope of the invention, but is merely representative of the various embodiments of the invention.

In this specification and the claims that follow, singular forms such as “a,” “an,” and “the” include plural forms unless the content clearly dictates otherwise. All ranges disclosed herein include, unless specifically indicated, all endpoints and intermediate values. In addition, “optional,” “optionally” or “or” refer, for example, to instances in which subsequently described circumstance may or may not occur, and include instances in which the circumstance occurs and instances in which the circumstance does not occur. The terms “one or more” and “at least one” refer, for example, to instances in which one of the subsequently described circumstances occurs, and to instances in which more than one of the subsequently described circumstances occurs.

The present disclosure covers methods, systems, and devices for potash processing. A potash processing systems uses a mechanical vapor recompression (“MVR”) cycle to increase the relative concentration of potash in a brine solution before separating the potash from the brine solution in a crystallizer. The system takes advantage of the energy efficiency of the MVR cycle and the temperature-dependent solubility characteristics of salt and potash in a brine solution to extract potash in an energy efficient and water saving process.

### Temperature Dependency of Salt and Potash Solubility in a Sylvinite Brine

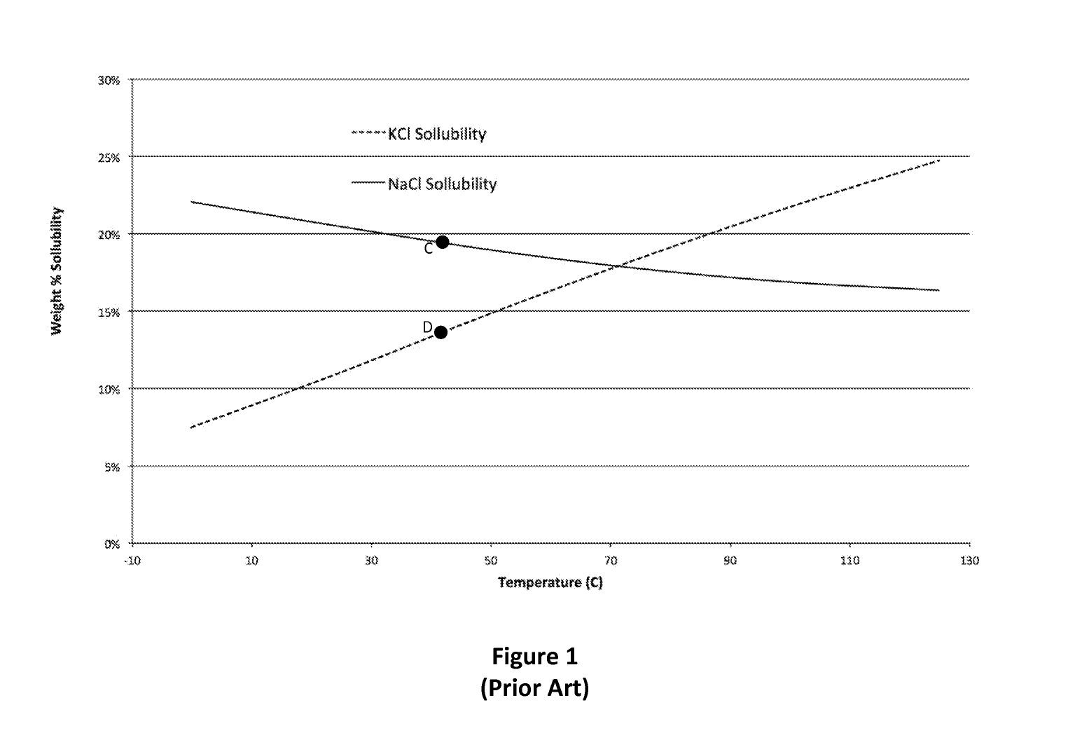

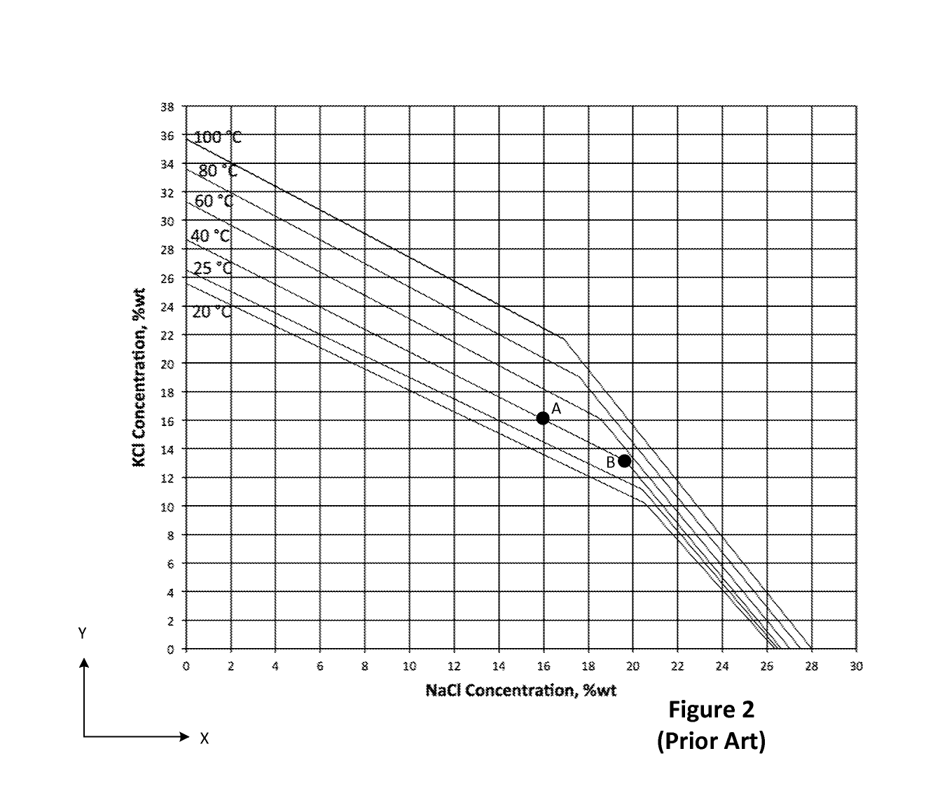

FIGS. 1 and 2 illustrate the temperature-dependent solubility of salt and potash in a salt-potash brine solution. FIG. 1 illustrates solubility equilibrium lines for salt and potash as a function of temperature in a salt-potash brine. FIG. 2 illustrates the weight percent solubility of salt and potash as a function of temperature in a salt-potash brine. Referring specifically to FIG. 1, in a mixture that has been allowed to reach solubility equilibrium and contains excess solid amounts of both salt and potash, for temperatures between 0° C. and 130° C., as temperature increases, the weight percent solubility of potash increases and the weight percent solubility of salt decreases. The weight percent solubility of potash and salt is about the same at 75° C. For example, in a 75° C. mixture containing excess solid amounts of both salt and potash, the weight-percent solubility of both salt and potash is about 17.9%. In the same solution, the weight-percent solubility of salt decreases to 16.8% at 105° C. and the weight-percent solubility of potash decreases to 13.4% at 35° C.

FIG. 2 illustrates that in a salt-potash brine, the weight percent solubility of salt is a function of the brine temperature and the amount of potash dissolved in the brine. Similarly, the weight percent solubility of potash is a function of the brine temperature and the amount of salt dissolved in the brine. The “knee” points for each constant-temperature line are the solubility equilibrium lines for salt and potash illustrated in FIG. 1. For example, at 40° C., a brine solution may contain about 16% salt and 16% potash (point “A” in FIG. 2). If the temperature of the brine is maintained at 40° C. and if the brine solution contains excess salt crystals or salt precipitate such that the brine solution is allowed to reach solubility equilibrium, some potash will precipitate out of the brine and some salt crystals will dissolve into the brine. The brine will eventually reach a solubility equilibrium (point “B” or the “knee” point on the 40° C. line in FIG. 2) of about 19% salt (point “C” in FIG. 1) and 13% potash (point “D” in FIG. 1) by weight.

A potash processing system may separate salt or potash from a salt-potash brine by heating and then cooling the salt-potash brine. For example, a salt-potash brine solution at 30° C. saturated with salt and potash has a weight percent salt concentration of about 20% and a weight percent potash concentration of about 12%. A salt precipitate may formed and suspended in the salt-potash brine by heating it to its boiling point, approximately 110° C. Additional salt precipitate may be formed as the salt-potash brine boils and water in the form of steam (or water vapor) leaves the brine. At the boiling temperature, the maximum weight percent solubility of the salt in the salt-potash brine is about 17%. The salt precipitate suspended in the brine may be mechanically captured to produce an NaCl-precipitated slurry. The remaining brine may be potash concentrated compared to the original, 30° C. brine, because less salt and less water are in the brine, i.e., the salt in the form of the NaCl-precipitated slurry has been mechanically removed and water, in the form of water vapor has boiled off. The potash-concentrated brine may then be cooled to form a potash precipitate in a potash-concentrated or potash-saturated brine. The potash precipitate may be mechanically captured to produce a potash-precipitated slurry.

The potash processing system and method may operate at optimal potash brine processing temperatures so as to maximize the amount of potash extracted from the brine for a given energy input and equipment cost.

### Potash Processing System Components

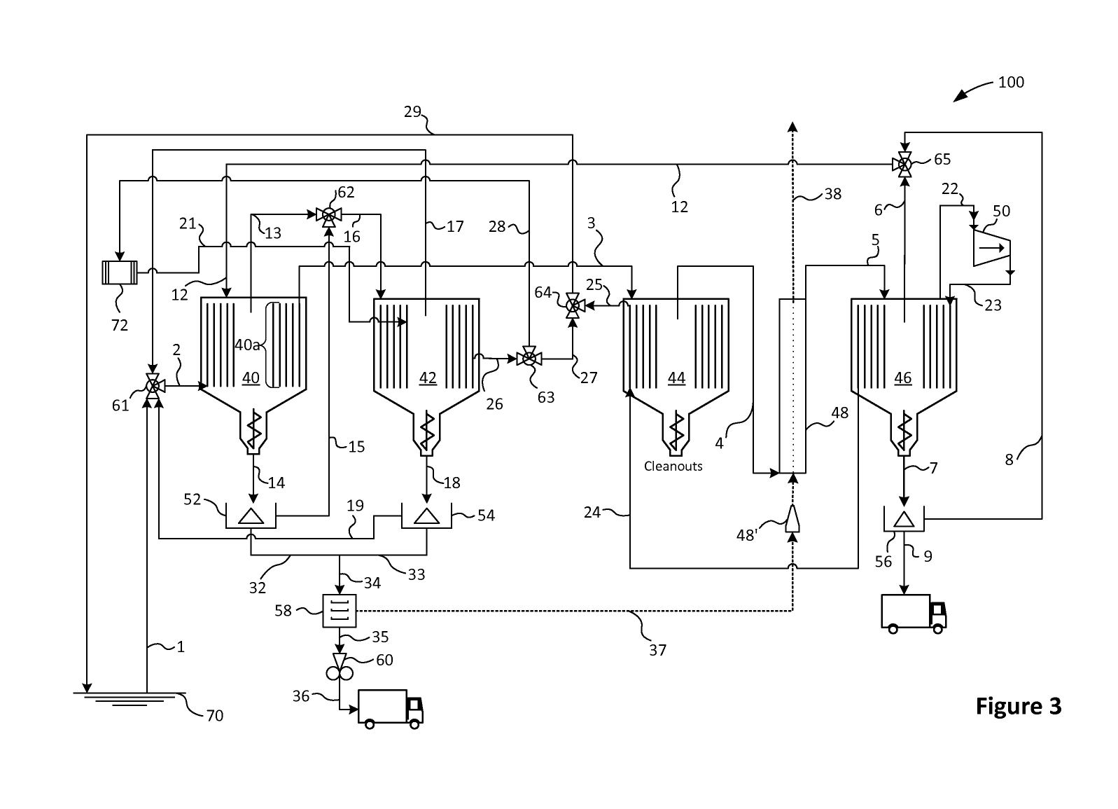

FIG. 3 illustrates an embodiment of a potash processing system 100. Potash processing system 100 may contain more or fewer components, than are described below, to optimize energy use to process or extract potash from a sylvinite brine source. In embodiments, a pump or other transport device transfers brine-containing potash 1 from a sylvinite brine source 70 to a mixing valve 61 and then a first-stage crystallizer 40. In FIG. 3, pumps or other transport devices are not shown. However, pumps or other transport devices, including gravity-fed pipes, may be sized and used between the various potash processing components according to standard engineering practices. Additionally, in FIG. 3, brine, water, or other fluids or gasses are depicted as lines between the illustrated components.

The brine-containing potash 1 leaving the sylvinite brine source 70 is preferably saturated with potash, meaning that decreasing the temperature of the brine-containing potash 1 will precipitate potash from the brine. The brine-containing potash is also likely salt saturated, meaning that increasing the temperature of the brine will precipitate salt from the brine. If the brine contains precipitated salt or potash, the precipitate may remain in suspension as a precipitate.

The brine-containing potash 1 may be combined in mixing valve 61 with second-stage potash centrifuge liquid 19 exiting a second-stage crystallizer centrifuge 54 and cooled brine 17 exiting the second-stage crystallizer 42. The combined solution, pre-first stage crystallizer cooling solution 2, then enters the first stage crystallizer 40. In embodiments, the pre-first stage crystallizer cooling solution 2 going into the first-stage crystallizer 40 may contain approximately 7% potash and 23% salt by weight. While in the first-stage crystallizer 40, the pre-first stage crystallizer cooling solution 2 is warmed by concentrated potash solution 12. As the brine is warmed, some salt may precipitate out of the pre-first stage crystallizer cooling solution 2. Similarly, as the concentrated potash solution 12 is cooled, some potash will precipitate out of the concentrated potash solution 12.

In embodiments, the first-stage crystallizer 40 may be configured to maintain precipitated salt in suspension as a precipitate in the pre-first stage crystallizer cooling solution 2. This may be done by maintaining relatively high fluid velocities inside the first-stage crystallizer cooling plates in the heat-exchanger portion 40a of the first-stage crystallizer 40. The relatively high fluid velocities may act to scrub the inside surfaces of the cooling plates to prevent the collection of precipitate (scaling) on the inside surfaces. The surfaces of the cooling plates may also be treated to prevent scaling or the collection of precipitate on the surfaces.

Likewise, the first-stage crystallizer 40 may be configured to prevent precipitated potash from collecting in the heat-exchanger portion 40a of the first-stage crystallizer 40. This may be done by having no horizontal surfaces on which precipitated potash may collect in the heat-exchanger portion 40a. The first-stage crystallizer 40 may also be configured to prevent precipitated potash from collecting in the heat-exchanger portion 40a by maintaining relatively high circular fluid velocities of the concentrated potash solution 12 in the heat-exchanger portion 40a of the first-stage crystallizer 40.

After cooling the concentrated potash solution 12 in first-stage crystallizer 40, the brine, now post-first stage crystallizer solution 3, may be fed or transported to the pre-heater 44 where the solution 3 is pre-heated. The solution 3 may be heated by concentrator condensate 24 coming from the concentrator heat exchanger 46.

A post pre-heater feed brine 4, which may have been heated to a temperature of 75° C. in pre-heater 44, may then be transported to an exhaust scrubber or direct heat exchanger 48, where the pre-heater feed brine 4 may be additionally heated to a temperature of 121° C., but maintained at a sufficiently high pressure to avoid boiling. The exhaust scrubber or direct heat exchanger 48 may be a vertical pipe and may be fed by dryer waste heat gas 37 emanating from the dryer 58. The post pre-heater feed brine 4 may be introduced at the bottom of the vertical pipe and allowed to exit near the top of the pipe as post-exhaust scrubber heated feed brine 5 into the concentrator 46. The dryer waste heat gas 37 may be bubbled up through the exhaust scrubber or direct heat exchanger 48 to add heat to the pre-heater feed brine 4 through direct contact.

More energy may be required to heat the post pre-heater feed brine 4 than may be provided solely by the dryer waste heat gas 37. If more energy is required, a gas supplied heater 48′ may be added such that direct heat exchanger 48 may become a gas-fired compact heat exchanger.

The direct heat exchanger 48 may also remove or capture from the dryer waste heat gas 37 any potash dust produced in the dryer 58. The exhaust scrubber or direct heat exchanger 48 thus advantageously uses waste energy in the dryer waste heat gas 37 to further heat the pre-heater feed brine 4 and capture potentially wasted potash dust produced in the dryer 58.

A post-exhaust scrubber heated feed brine 5, which may now be at a temperature of 121° C., may then be fed or transported to the concentrator 46. The concentrator 46 takes advantage of the temperature dependent solubility properties of salt in the feed brine 5 to extract salt from the brine solution. In embodiments, the latent heat recovered from condensing vapor, which becomes concentrator condensate 24, may be used to boil heated feed brine 5. As the concentrator 46 further heats the brine, salt crystals or precipitate form in the solution because salt is less soluble in a salt-potash brine at higher temperatures. The brine may also be brought to a boil, extracting water in the form of water vapor and causing additional salt crystals or precipitate to form in the salt-potash brine solution, formerly heated feed brine 5. The concentrator 46 may be configured to separate the salt precipitate from the salt-potash brine, leaving a potash-rich brine 6. Precipitated salt may leave the concentrator in the form a salt-precipitated slurry 7. The salt-precipitated slurry 7 may then be processed through a concentrator centrifuge 56 to extract brine in the form of salt-centrifuge liquid 8. The remaining solid salt 9 may be captured or removed from the potash processing system 100. The solution leaving the concentrator 46 may be referred to as potash-rich concentrate 6 and salt-centrifuge liquid 8, both containing relatively high concentrations of potash. Potash-rich concentrate 6 and salt-centrifuge liquid 8 may be referred to as potash-concentrated brine or concentrated potash solution 12.

The pre-heater 44 and the concentrator 46 may be heated by work converted to heat, the work produced by a mechanical vapor recompression (“MVR”) cycle. Concentrator vapor 22 may be extracted from a boiling brine solution in concentrator 46. The concentrator vapor 22 enters the compressor or blower 50, which produces compressor discharge vapor 23. The compressor discharge vapor 23 enters the coils of the concentrator 46 to boil the post-exhaust scrubber heated feed brine 5. As the post-exhaust scrubber heated feed brine 5 cools the compressor discharge vapor 23, the vapor 23 may condense to form concentrator condensate 24.

The concentrator condensate 24 may then be pumped or transported to the pre-heater 44 to heat the post-first stage crystallizer solution 3. The post-first stage crystallizer solution 3 may further cool the concentrator condensate 24 to produce warm condensate 25.

After leaving the concentrator 46, potash-rich concentrate 6 and salt-centrifuge liquid 8 may be combined in a mixing valve 65 to become concentrated potash solution 12. The temperature of concentrated potash solution 12 may be about 105° C. Concentrated potash solution 12 may have a higher concentration of potash because it may contain less dissolved salt than the original post-exhaust scrubber heated feed brine 5. However, due to its relatively high temperature, concentrated potash solution 12 may not be potash saturated, meaning more potash may be able to dissolve into concentrated potash solution 12. The potash concentrate solution 12 may be transferred to first-stage crystallizer 40.

The first-stage crystallizer 40 takes advantage of the temperature dependent solubility properties of potash in the potash concentrated solution 12. The first-stage crystallizer 40 cools the potash concentrated solution 12, causing potash to precipitate out of the solution and form potash precipitate that may be suspended in the brine. The first-stage crystallizer 40 may then separate the potash precipitate from the solution and form first-stage potash crystallizer slurry 14.

The pre-first stage crystallizer cooling solution 2, which may comprise brine-containing potash 1, cooled brine 17, and second-stage potash centrifuge liquid 19, may be used to cool concentrated potash solution 12 in the first-stage crystallizer 40. Both second-stage potash centrifuge liquid 19 and cooled brine 17 may be referred to as cooled saturated brine because they are roughly the same temperature and contain the same concentration by weight of dissolved potash.

Because both the cooled brine 17 and the second-stage potash centrifuge liquid 19 come from the second stage crystallizer 42, the temperature of cooled brine 17 and the second-stage potash centrifuge liquid 19 may be at a lower temperature than effluents 3-16, 18, 20, 22-25, and 27-29, identified in FIG. 3. The relatively low temperature of cooled brine 17 and second-stage potash centrifuge liquid 19, combined with the relatively low temperature of the source brine 1, may be used to advantageously cool concentrated potash solution 12 in first-stage crystallizer 40. Additionally, the relatively warm concentrated potash solution 12 warms the brine-containing potash 1, the recycled cooled brine 17, and the second-stage potash centrifuge liquid 19, reducing the energy required to heat post-first stage crystallizer solution 3 in the pre-heater 44 or concentrator 46. Thus, recycling cooled brine 17 and the second-stage potash centrifuge liquid 19 reduces the energy required to concentrate and then extract potash from the brine-containing potash 1. In addition, recycling cooled brine 17 and the second-stage potash centrifuge liquid 19 reduces the water consumption of the potash processing system 100.

After leaving first-stage crystallizer 40, first-stage potash crystallizer slurry 14 may be transferred to the first-stage crystallizer centrifuge 52. The centrifuge 52 may extract first-stage centrifuge liquid 15 from the first-stage potash crystallizer slurry 14 to produce a potash paste 32. The liquid 15 may be combined with the cooled potash-rich concentrate 13 in mixing valve 62 before being transported as second-stage crystallizer supply 16 to the second-stage crystallizer 42. Both the first-stage centrifuge liquid 15 and the potash-rich concentrate 13 may be referred to as saturated-potash brine because they are saturated or nearly saturated with dissolved potash. Second-stage crystallizer supply 16 may be at a temperature of 65° C. and may contain approximately 17% potash and 18% salt by weight.

Similar to the first-stage crystallizer 40, second-stage crystallizer 42 uses the temperature dependent solubility properties of potash in the second-stage crystallizer supply 16 to remove additional potash from the salt-potash brine. Second-stage crystallizer 42 may cool the second-stage crystallizer supply 16 to approximately 30° C., causing potash to precipitate out of the solution and form potash precipitate that may be suspended in the brine. The second-stage crystallizer 42 may then separate the potash precipitate from the solution and form second-stage potash crystallizer slurry 18.

Second-stage crystallizer 42 may be cooled by a cooling source 72, with cooling supply line 21. In locations where a ground water aquifer is accessible, the cooling source 72 may be a ground water aquifer.

After leaving second-stage crystallizer 42, second-stage potash crystallizer slurry 18 may be transferred to the second-stage crystallizer centrifuge 54. The centrifuge 54 may extract liquid 19 from the second-stage potash crystallizer slurry 18 to produce a potash paste 33.

The potash paste 32 produced from the first-stage crystallizer centrifuge 52 and the potash paste 33 produced from the second-stage crystallizer centrifuge 54 may be combined into combined paste 34 and transferred to dryer 58. Dryer 58 may produce dried potash 35, which may be transferred to pelletizer 60 to produce potash pellets 36. The dried potash pellets 36 may be used in products such as fertilizer.

### Additional Embodiments

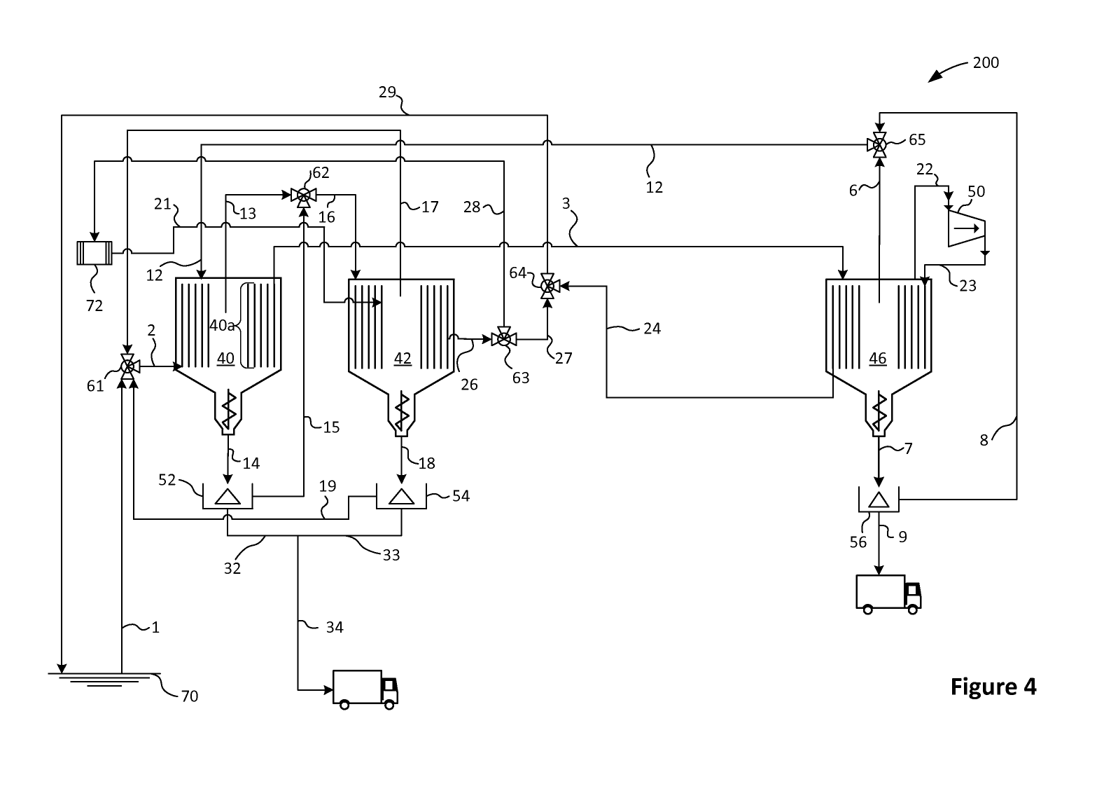

Referring now to FIG. 4, a potash processing system 200 may contain fewer components than those in potash processing system 100 illustrated in FIG. 3. For example, there is no pre-heater in potash processing system 200 such that post-first stage crystallizer solution 3 is directly transported to concentrator 46. Additionally, concentrator condensate 24 is combined with remaining post-second stage crystallizer cooling water 26 without being used to pre-heat post-first stage crystallizer solution 3.

Other potash processing components are also not present in potash processing system 200. For example, dryer 58 and pelletizer 60 have been removed from potash processing system 200. Other components may be combined. FIG. 4 illustrates separate centrifuges 52 and 54, which may be combined as a single centrifuge. In embodiments, first-stage centrifuge liquid 15 and second-stage centrifuge liquid 19 may be combined if centrifuges 52 and 54 are combined.

A potash processing system 200 with fewer components may have a lower capital cost investment but may be less efficient and require more energy to operate. For example, if pre-heater 44 and exhaust scrubber or direct heat exchanger 48 do not pre-heat post-first stage crystallizer solution 3, the entire heat required to boil post-first stage crystallizer solution 3 will have to come from work produced by the compressor or blower 50 in the MVR cycle.

### Energy Efficiency

Referring back to FIG. 3, the potash processing system may operate at unique thermodynamic operating conditions and re-use the energy (or lack thereof) stored in the various effluents to minimize power consumption and increase the useful life of the components. For example, in embodiments, cooled brine 17 and second-stage potash centrifuge liquid 19 are recycled or combined with source brine 1 to cool the concentrated potash solution 12 in the first-stage crystallizer 40. Except for the energy used to transfer cooled brine 17 and second-stage potash centrifuge liquid 19, the first-stage crystallizer 40 requires no extra energy to precipitate potash from concentrated potash solution 12. Likewise, concentrated potash solution 12 warms pre-first stage crystallizer solution 3, which is a combination of source brine 1, cooled brine 17, and second-stage potash centrifuge liquid 19. Thus, the first-stage crystallizer 40 also may also act as a heater used to concentrate the source brine 1 in the potash processing system 100.

Additionally, in embodiments, concentrator condensate 24 may be used in pre-heater 44 to raise the temperature of the post first-stage crystallizer solution 3 before the condensate (now warm condensate 25) is returned to the sylvinite brine source 70. Likewise, energy stored in dryer waste heat gas 37 may be used to heat post pre-heater heated feed brine 4 in exhaust scrubber or direct heat exchanger 48 before being expelled to the atmosphere as scrubber waste heat gas 38.

### Water Conservation

As compared to evaporation-pond potash processing techniques that consume significant amounts of water, potash processing system 100 may consume very little water. In embodiments, the system described above may be closed-loop, meaning much of the water, except for water lost by drying the combined solid potash 34 and water contained in solid salt 9, may be returned to the sylvinite brine source 70 or the aquifer or cooling source 72. In embodiments, the potash processing system 100 may be configured to return to the sylvinite brine source 70 more than 80% of the water extracted from the sylvinite brine source 70. In other embodiments, the potash processing system 100 may be configured to return to the sylvinite brine source 70 more than 85, 90, 92, 94, 96, or 98% of the water extracted from the sylvinite brine source 70.

For example, referring again to FIG. 3, cooling water exits the second-stage crystallizer 42 as post-second stage crystallizer cooling water 26, which is fed to distribution manifold or valve 63. A portion of post-second stage crystallizer cooling water 26 is returned to the aquifer as the aquifer water return 28. The remaining post-second stage crystallizer cooling water 27 is returned to the sylvinite brine source 70. Therefore, little if any of the aquifer water is lost to evaporation.

Similar to the cooling water, the source brine 1, which eventually becomes warm condensate 25, may also be recycled. Warm condensate 25 coming from the pre-heater 44 may be combined with the remaining post-second stage crystallizer cooling water 27 in mixing valve 64 to become return solution 29. Return solution 29 may be returned to the sylvinite brine source 70. Thus, even the brine solution, which starts as source brine 1, may be recycled back to the sylvinite brine source 70 with very little water lost to evaporation.

### Potash Retention

Potash processing system 100 may be configured to capture almost all the potash extracted from the sylvinite brine source 70. For example, source brine 1 becomes concentrator vapor 22 before becoming warm condensate 25. As boiled water vapor, concentrator vapor 22 does not contain salt or potash. Concentrator vapor 22 eventually becomes warm condensate 25, which also does not contain salt or potash. Warm condensate 25 may be combined with remaining post-second stage crystallizer cooling water 27, and returned to sylvinite brine source 70 as return solution 29. Therefore, no potash or salt is re-injected back into sylvinite brine source 70. Some potash may be dissolved in the small amount of water (e.g., brine) contained in solid salt 9. Therefore, in embodiments, the potash processing system may be configured to capture from the sylvinite brine source 70 more than 80% of the potash extracted from the sylvinite brine source 70. In other embodiments, the potash processing system 100 may be configured to capture from the sylvinite brine source 70 more than 85, 90, 92, 94, 96, or 98% of the potash extracted from the sylvinite brine source 70.

Likewise, second-stage potash centrifuge liquid 19 and cooled brine 17, both containing relatively high concentrations of potash, are mixed with source brine 1 such that they are recycled back into potash processing system 100. Therefore, the only effluent re-injected back into the sylvinite brine source 70 is return solution 29, which does not contain salt or potash.

Not re-injecting brine containing potash back into the sylvinite brine source 70 has several benefits. For example, less source brine 1 needs to be extracted from the brine source 70 to produce a given amount of processed potash. Extracting less source brine 1 reduces the amount of energy required by potash processing system 100 to process the potash and reduces the energy required to pump source brine 1 out of sylvinite brine source 70. Similarly, reducing the amount of source brine 1 for processing reduces flow rates inside a hole or cavern that is the sylvinite brine source 70. Reduced flow rates inside a sylvinite cavern increases residence time for an effluent to become fully saturated with potash inside the sylvinite cavern and thus produces a higher-quality source brine 1.

### Incremental Heating and Cooling

Referring again to FIG. 3, potash processing system 100 incrementally heats and then cools the source brine 1 to extract salt and then potash from the source brine 1. For example, in potash processing system 100, source brine 1 may be first gradually heated by concentrated potash solution 12 in first-stage crystallizer 40. Post-first stage crystallizer solution 3 may then be further heated by concentrator condensate 24 in pre-heater 44 before additional heating by dryer waste heat gas 37 in exhaust scrubber or direct heat exchanger 48. Similarly, concentrated potash solution 12 may first be incrementally cooled by pre-first stage crystallizer cooling solution 2 in first-stage crystallizer 40 before being additionally cooled by an aquifer water supply 21 in second stage crystallizer 42.

Incremental heating and cooling is believed to produce larger salt and potash crystals, which decreases the amount of post-processing (e.g., drying, pelletizing) and produces a higher-grade final product. In addition, larger crystal formation is believed to increase the life of potash processing components, especially centrifuge life.

### System Modularity and Transportability

Various components described as being part of the potash processing systems 100 or 200 may or may not be included depending on the site-specific needs and the desired end product. The potash processing system 100 or 200 may be mobile and modular, meaning that different components may be built on transportable skids and used, replaced, or upgraded as needed. For example, the pre-heater 44, concentrator 46, and components in the MVR cycle (compressor or blower 50) may be combined on a single transportable skid. Similarly, the first and second stage crystallizers 40 and 42, centrifuges 52 and 54, dryer 58, or pelletizer 60 may be combined on a transportable skid.

The components of the potash processing system 100 may be scalable according to the potash processing needs of typical or specific potash well sites. For example, at some well sites, it may be possible to extract and process the brine source 1 at much higher rates. Increased processing rates will likely require a larger capacity blower or compressor 50 as part of the MVR cycle, additional first or second stage crystallizers 40 and 42, additional pre-heaters 44, or additional concentrators 46. Other potash processing system 100 or 200 components may also be sized, added, or removed according to the processing needs of a specific well site.

### Variations on Described Embodiments

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

The components of the disclosed embodiments, as generally described herein, could be arranged and designed in a wide variety of different configurations. Accordingly, the above detailed description of the embodiments of the systems and methods of the disclosure is not intended to limit the scope of the disclosure, but is merely representative of possible embodiments of the disclosure. In addition, the steps of any disclosed method do not necessarily need to be executed in any specific order, or even sequentially, nor do the steps need be executed only once, unless otherwise specified.

In the above description of embodiments, various features are sometimes grouped together in a single embodiment, figure, or description thereof for the purpose of streamlining the disclosure. This method of disclosure, however, is not to be interpreted as reflecting an intention that any claim requires more features than those expressly recited in that claim. Rather, inventive aspects lie in a combination of fewer than all features of any single foregoing disclosed embodiment. Changes may be made to the details of the above-described embodiments without departing from the underlying principles set forth herein.

What is claimed is:

1. A potash processing system, the system comprising:
a first-stage and a second-stage crystallizer;
a concentrator; and
wherein the potash processing system is configure to:
receive a sylvinite brine comprising potash, salt, and water from a sylvinite brine source;
boil the sylvinite brine in the concentrator to produce precipitated salt, water vapor, and potash-concentrated brine;
cool the potash-concentrated brine in the first-stage crystallizer to produce first-stage precipitated potash and saturated-potash brine; and
cool the saturated-potash brine in the second-stage crystallizer to produce second-stage precipitated potash and cooled saturated-potash brine.

2. The potash processing system of claim 1, wherein the potash processing system is further configured to return to the sylvinite brine source more than 80% of the water in the sylvinite brine received from the sylvinite brine source.

3. The potash processing system of claim 1, wherein the potash processing system is further configured to capture from the sylvinite brine more than 80% of the potash in the sylvinite brine received from the sylvinite brine source.

4. The potash processing system of claim 3, wherein the potash processing system is configured to recycle the cooled saturated-potash brine back in with the sylvinite brine prior to boiling the sylvinite brine.

5. The potash processing system of claim 1, further comprising a mechanical vapor recompression cycle, wherein the water vapor produced in the concentrator is compressed by a blower in the mechanical vapor recompression cycle to produce superheated vapor and the potash processing system is configured to boil the sylvinite brine in the concentrator with heat from the superheated vapor.

6. The potash processing system of claim 5, further comprising a pre-heater configured to pre-heat the sylvinite brine from condensate produced by the concentrator.

7. The potash processing system of claim 6, wherein the mechanical vapor recompression cycle and the pre-heater are installed together on a single transportable skid.

8. The potash processing system of claim 1, wherein the potash processing system is configured to combine the sylvinite brine and the cooled saturated-potash brine into a pre-first stage crystallizer cooling solution and cool the potash-concentrated brine in the first-stage crystallizer with the pre-first stage crystallizer cooling solution.

9. The potash processing system of claim 1, further comprising:
a first-stage crystallizer centrifuge configured to extract potash paste from the first-stage precipitated potash and the saturated potash brine;
a second-stage crystallizer centrifuge configured to extract potash paste from the second-stage precipitated potash and the cooled saturated-potash brine;
a dryer configured to dry the potash paste from the first-stage precipitated potash and the potash paste extracted from the cooled saturated-potash brine and produce dried potash and dryer waste heat gas; and
an exhaust scrubber configured to heat the sylvinite brine with the dryer waste heat gas.

10. A method for extracting potash from a sylvinite brine source, the method comprising:
receiving a sylvinite brine comprising potash, salt, and water from a sylvinite brine source;
boiling the sylvinite brine in a concentrator to produce precipitated salt, water vapor, and potash-concentrated brine;
cooling the potash-concentrated brine in a first-stage crystallizer to produce first-stage precipitated potash and saturated-potash brine; and
cooling the saturated-potash brine in a second-stage crystallizer to produce second-stage precipitated potash and cooled saturated-potash brine.

11. The method of claim 10, further comprising returning to the sylvinite brine source more than 80% of the water received from the sylvinite brine source.

12. The method of claim 11, further comprising retaining from the sylvinite brine more than 80% of the potash received from the sylvinite brine source.

13. The method of claim 12, further comprising combining the cooled saturated-potash brine and the sylvinite brine into a brine cooling solution prior to boiling the sylvinite brine in the concentrator.

14. The method of claim 10, wherein boiling the sylvinite brine in the concentrator comprises producing superheated water vapor by compressing the water vapor with a blower in a mechanical vapor recompression cycle and transferring heat from the superheated water vapor into the sylvinite brine.

15. The method of claim 10, wherein cooling the potash-concentrated brine in the first-stage crystallizer comprises cooling the potash-concentrated brine with the sylvinite brine and the cooled saturated-potash brine.

16. The method of claim 10, further comprising pre-heating the sylvinite brine in a pre-heater with condensate produced by the concentrator.

17. The method of claim 10, further comprising:
extracting potash paste from the first-stage precipitated potash and the saturated potash brine in a first-stage crystallizer centrifuge;
extracting potash paste from the second-stage precipitated potash and the cooled saturated-potash brine in a second-stage crystallizer centrifuge;
drying the potash paste in a dryer to produce dried potash and dryer waste heat gas; and
heating the sylvinite brine with the dryer waste heat gas in an exhaust scrubber prior to the sylvinite brine entering the concentrator.

18. The method of claim 10, wherein the first-stage crystallizer and the second-stage crystallizer are installed together on a single transportable skid.

19. The method of claim 10, further comprising:
incrementally heating the sylvinite brine in the first-stage crystallizer, then a pre-heater, and then the concentrator to produce the potash concentrated brine;
and then incrementally cooling the potash concentrated brine in the first-stage crystallizer and then the second-stage crystallizer to produce precipitated potash.

20. The method of claim 10, wherein a boiling temperature of the sylvinite brine is used as the feedback control for a sylvinite brine feed flow rate through the concentrator.
